(19) United States
(12) Patent Application Publication
(10) Pub. No.: US 2016/0289913 A1
(43) Pub. Date: Oct. 6, 2016

(54) CLOSURE FOR LOCKING A COVERING

(71) Applicant: ACO SEVERIN AHLMANN GMBH & CO KOMMANDITGESELLSCHAFT, Büdelsdorf (DE)

(72) Inventors: James Canney, Bedfordshire (GB); Jérôme Dubois, Louviers (FR); Didier Ollivier, Ecardenville sur Eure (FR)

(21) Appl. No.: 14/442,511

(22) PCT Filed: Nov. 13, 2013
(86) PCT No.: PCT/EP2013/073671

§ 371 Date: May 13, 2015

(30) Foreign Application Priority Data
Nov. 14, 2012 (DE) 10 2012 110 941.9

(51) Int. Cl. E02D 29/14; E05B 35/00; E01C 11/22; E05B 65/00; E02B 5/08; E03F 5/06

(52) U.S. Cl. CPC E02D 29/1427; E02D 29/14; E02B 5/085; E03F 5/06; E01C 11/227; E05B 65/006; E05B 35/008; E02D 2300/0006

(57) ABSTRACT

Coverings for structures which can be installed in the ground are known. For example, these are drainage channels or manholes. In order to lock the covering on the structure, closures are known which comprise a snap bolt which is designed in such a way and is mounted movably on the covering (20) against the force of a spring device in such a way that, during closing of the covering (20), the snap bolt is forced back and snaps in behind a counterbearing (14, 14′) fixed to the structure in a closure position. To simplify the arrangement and also to improve durability, it is proposed that the snap bolt is mounted in a housing (40) which can be fastened in a housing receptacle of the covering (20).

The invention relates to a closure for locking a cover on a structure that can be installed in the ground according to the preamble of claim 1, and a cover designed accordingly.

For the drainage of surfaces, drainage channels are known, comprising a channel that can be installed in the ground and a cover attached to the channel, such that the drainage channel can be driven over. Further structures are point drainages or manholes, which likewise must be closed, such that they do not interfere with traffic. In any case, however, the important thing is that the attachment of the cover on the structure installed in the ground is secure.

On the other hand, it is important that the installation and the dismantling of the cover on the structure be very simple, because cleaning work is frequently necessary.

Closures for covers, or covers, respectively, are known from U.S. Pat. No. 3,201,161 or U.S. Pat. No. 1,693,190, comprising a latch, which is mounted on the cover and can move against the force of a spring, such that the snap bolt is forced back when closing the cover, and snaps in place in a closed position behind a counter bearing fixedly attached to the structure.

The known closures, and covers, respectively, however, have a very complex construction. Furthermore, the closures, and covers, respectively, are prone to corrosion, such that after a certain time in use, a proper functioning thereof is no longer ensured.

The invention addresses the object of further developing a closure for locking a cover, and a cover having a closure of this type, respectively, such that, with a simple construction and a simple installation, a durable functionality is ensured.

This object is achieved by means of a closure according to Claim 1, and a corresponding cover, respectively.

This object is achieved, in particular, by means of a closure for locking a cover on a structure that can be installed in the ground, e.g. a drainage channel or a manhole, having a latch, which is designed such, and is movably mounted on the cover, against the force of a spring device, such that the snap bolt is forced back when closing the cover and snaps in place behind a counter bearing fixedly attached to the structure, wherein the latch is mounted in a housing, which can be secured in a housing receptacle in the cover. The object is also achieved by means of a cover having a closure of this type.

A substantial aspect of the invention is that the latch is no longer mounted directly in the cover and its components, but rather, a housing is provided, which, in turn, is secured in the cover. As a result, it is possible to create a closed unit, composed of a housing and the moving parts, in which the individual elements are coordinated to one another. This entire component can then, in turn, be attached to the cover.

It is possible for the housing of the latch to be open toward the bottom. As a result, the individual components of the latch, e.g. the snap bolt and compression spring, can be readily maintained or replaced. Furthermore, dirt that has infiltrated the housing falls out of the housing that is open toward the bottom, due to the gravity, when the grate is locked, and an impairment of the functioning of the latch due to contaminants in the housing is counteracted.

The housing receptacle is preferably designed as a recess in the edge of the cover, in which the housing is attached in the closed position, such that it cannot be released. The structure, i.e. the drainage channel or the manhole, which always has an edge (a frame) in structures of this type, simultaneously forms an element thereby, which secures the housing, and thus the latch in the cover.

The housing is preferably designed such that it is closed at its upper surface in the closed position. As a result, it is possible to keep substances compromising the function of the latch, any infiltration of dirt or the like, away from the latch.

The housing preferably has a retaining groove (or a retaining tongue), by means of which the housing can be fixed in a recess in the cover, which has a complementary retaining tongue (or retaining groove, respectively). The housing (and thus the latch) is thus secured in the cover in a form-fitting manner, with extremely little assembly effort.

The housing and/or the latch are preferably made of plastic. In particular, an injection molding procedure is suitable for this. As a result of this material selection, a simple production, on one hand, and a high corrosion resistance on the other hand, is ensured.

Furthermore, the housing is preferably designed such that it can be inserted in the recess in a direction of movement for the snap bolt. This means that in the closed position of the snap bolt, the housing can no longer be moved, and at the same time it is thus securely connected to the cover.

The housing preferably has a guide encompassing the latch. As a result, a securely functioning bearing of the latch is ensured over time.

The snap bolt preferably has a stop, which limits its movement in the closing direction. The latch, together with the housing, is thus comparable to a mortise lock that can be installed in a door.

Lastly, the latch preferably comprises a clamping device, by means of which the spring device can be connected to the snap bolt. As a result, it is ensured that the assembly can be assembled in a particularly simple manner.

A further substantial aspect of a closure, or a cover, respectively, of the type illustrated here lies in the operability when opening the cover. In order to simplify this, it is proposed that the housing have an engagement recess in a front region, from which the snap bolt protrudes, such that the snap bolt can be slid back to an open position by means of a tool, e.g. a screwdriver, inserted through the engagement recess from above. This engagement recess thus also directly indicates to the user where the tool is to be applied.

The housing, furthermore, preferably has an engagement bevel on its underside, beneath the snap bolt, by means of which the cover can be lifted away from the structure using a tool, e.g. a screwdriver. Thus, using the same tool, on one hand the latch can be opened, and on the hand, the opening tool is then used for lifting the cover.

The counter bearing is preferably designed as a two-piece bearing, such that a tool, e.g. a screwdriver, can be inserted between the two parts of the counter bearing, in order to engage with the snap bolt. As a result, a targeted positioning of the tool can be very easily achieved.

Furthermore, a bevel is preferably formed under the counter bearing, such that a tool, e.g. a screwdriver, which is used for opening the latch, is displaced by means of this bevel in the opening direction, when it is applied to and in contact with the bevel. The tool is thus deflected by this bevel.

In the following description, a preferred embodiment of the invention shall be explained in greater detail, based on drawings. Therein:

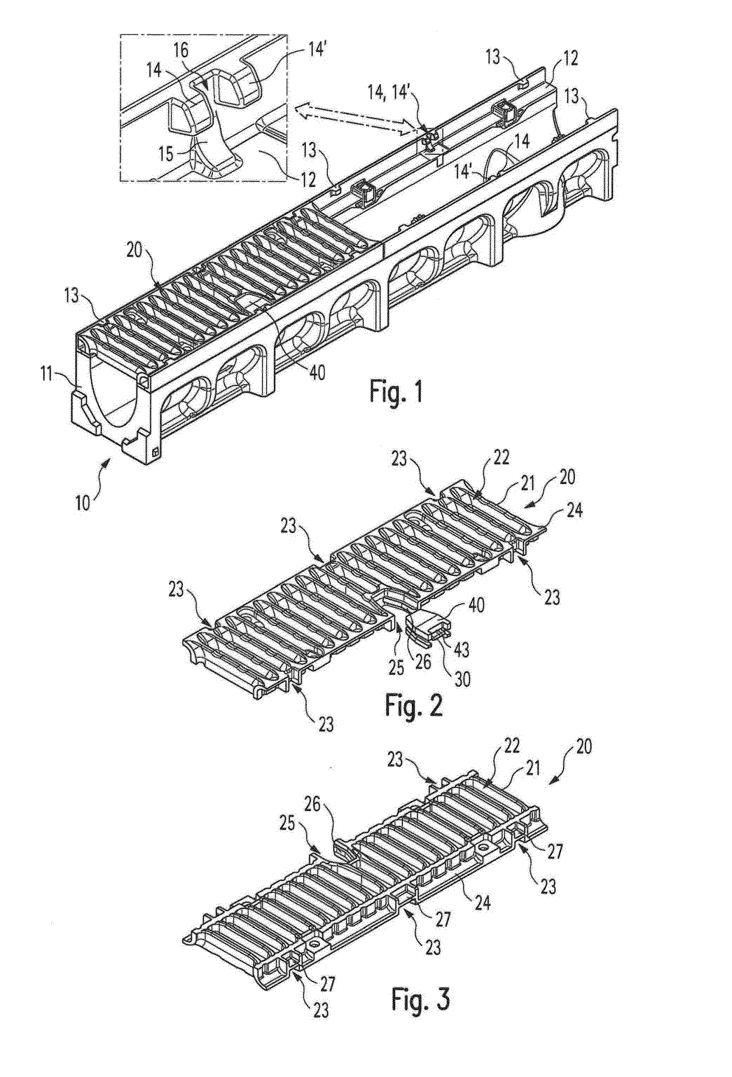

FIG. 1 shows a perspective depiction of a drainage channel with a partially applied cover,

FIG. 2 shows a perspective view of the cover according to FIG. 1, diagonally from above,

FIG. 3 shows a perspective depiction of the cover according to FIG. 1, diagonally from below,

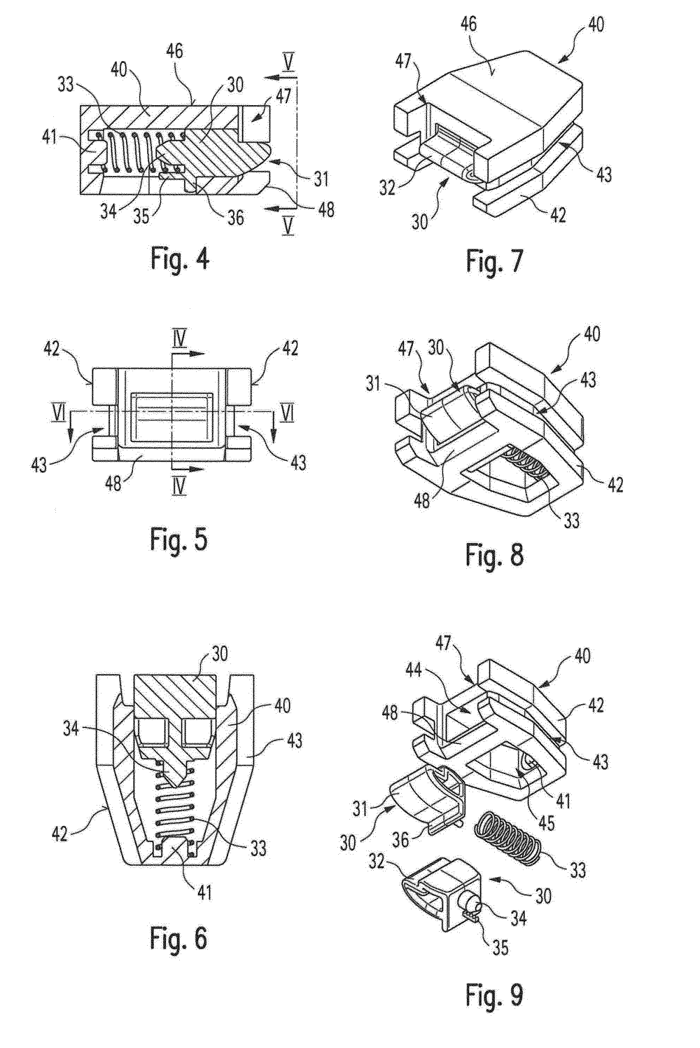

FIG. 4 shows a longitudinal section, cut through an embodiment of the closure,

FIG. 5 shows a view of the closure along the line V-V from FIG. 4,

FIG. 6 shows a cut along the line VI-VI from FIG. 5,

FIG. 7 shows a perspective view of a closure, diagonally from above,

FIG. 8 shows a perspective view of the closure according to FIG. 7, diagonally from below,

FIG. 9 shows an exploded view of the closure according to FIGS. 7 and 8,

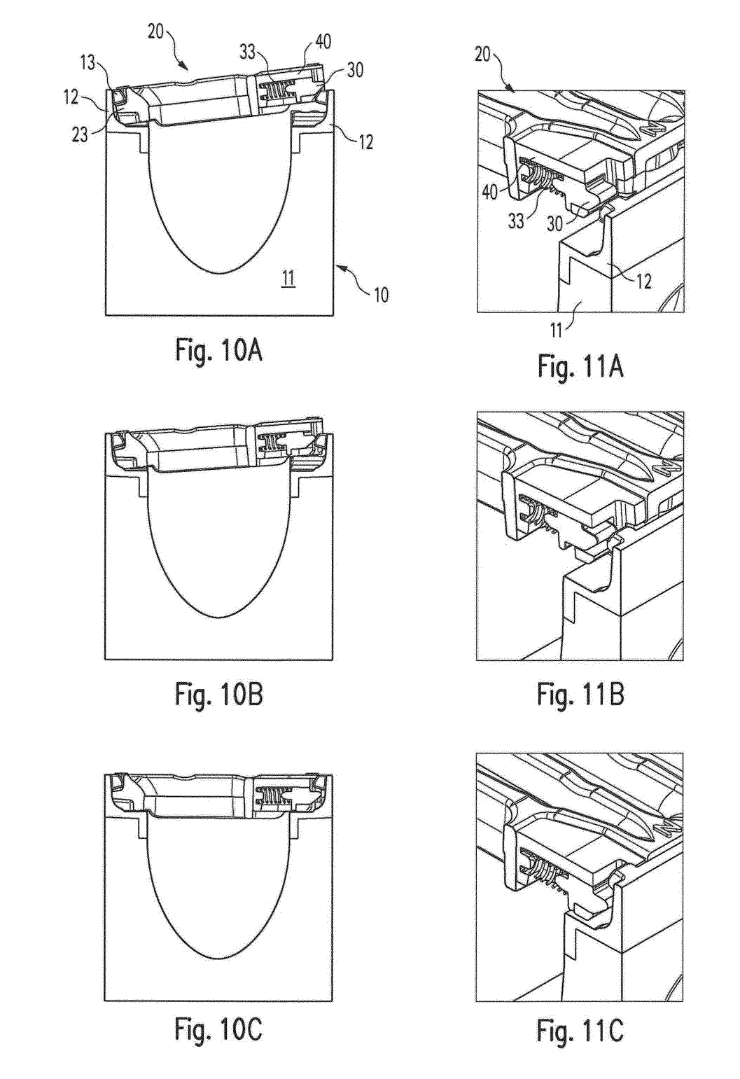

FIGS. 10A-10C show a cross-section through a cover having a closure and drainage channels corresponding to the embodiment according to FIG. 1, in various assembled positions, and

FIGS. 11A-11C show perspective partial sectional depictions corresponding to the assembled positions of the assembly according to FIGS. 10A-10C.

In the following description, the same reference numerals shall be used for components that are identical and have an identical function.

As is shown in FIGS. 1-3, a structure that can be installed in the ground—in this case, as exemplified by a drainage channel—comprises a structure 10 having a channel body 11, the upper edge of which is formed by frames 12 in the known manner. A cover 20 is placed with the underside of its bearing surface 24 on the drainage channel 10, or between the frames encompassing it at the sides. The cover 20, in the exemplary embodiment of a drainage channel shown here, comprises channel ribs 21, between which slots 22 are formed, such that surface water can flow into the channel.

Both frames 12 of the structure 10 have an identical design. On one hand, they have lugs 13 at regular intervals, which protrude inward, and on the other hand, latch counter bearings 14, 14′ are disposed between these lugs 13, which are formed as “twins” and which have a tool passage 16 between one another. A bevel 15 is provided beneath the tool passage 16, which, when a tool, e.g. a screwdriver, is inserted in the tool passage 16, then forces the front edge of the blade of the screwdriver toward the middle of the channel body 11.

The cover 20, in turn, has an asymmetrical design, and has notches 23 on one of its edges, into which the lugs 13, or the counter bearings 14, 14′ fit. On one side of the cover, these notches 23 are closed by a transverse rib 27. This is shown in FIG. 3. Notch ribs 27 of this type—as shown in FIG. 2—are not provided in the notches 23 on the opposite side of the cover. As a result, when placing the cover 20 on the structure 10, it is possible to first hook the cover 20 in place, in an inclined position (relative to the longitudinal axis), with the notch ribs 27 underneath the lugs 13, or the latch counter bearings 14, 14′, respectively, and then lower the cover 20 in place. As a result, the cover 20 is securely held on the corresponding frame 12, or the channel body 11, respectively, in the closed state by the lugs 13 and the latch counter bearing 14, 14′ on the one side.

On the side of the cover 20 opposite the notches 23 having notch ribs 27, an enlarged recess 25 is provided opposite the central notch 23, into which a housing 40 can be inserted (inward from the outside). The housing 40 has—as is illustrated, in particular, in FIGS. 5 to 9—retaining grooves 43 on its exterior. The retaining tongues 26 corresponding to the retaining grooves are disposed in the recess 25. Thus, the housing 40 can be inserted into the recess 25 from the outer edge of the cover 20. The dimensioning in this case is carried out, such that the housing 40, once it has been inserted, is securely seated in a form-fitting and friction-locking manner in the cover 20.

The housing 40 has a closed surface 46, while the underside of the housing has an insertion opening 45. Furthermore, the housing has a recess 47 on its front surface, which faces outward in the inserted state. Furthermore, this front surface is opened by a guide 44, on the lower edge of which an engagement bevel 48 is provided.

A latch 30, having a lower bevel 31 and an upper retaining surface 32, can be inserted in the interior of the housing 40. A pin-shaped spring seat 34 is attached to its inner end, opposite the bevel 31 and the retaining surface 32, beneath which a clamping tongue 35 is seated. A stop 36 is provided between the spring seat 34 and the bevel 31, or retaining surface 32, respectively, which broadens the latch 30 such that, although it can be inserted in the guide, with the bevel 31 and the retaining surface 32 protruding over the front surface of the housing into the recess 47, it does not, however, extend out of this guide 44.

A compression spring 33 can be placed on the spring seat 34 such that it is held in place on the pin-shaped spring seat 34 by the clamping tongue 35—as is shown, in particular, in FIG. 4. The end of the compression spring 33 opposite the stop 36 can be placed in a spring seat 41 in the housing 40, such that the position shown in FIGS. 4, 6 and 8 is then achieved. In this position, the compression spring 33 thus pushes the snap bolt 30 outward, such that it protrudes from the housing 40.

The placement and locking of a cover 20 on a structure 10 is described below based on FIGS. 10A to 10C and 11A to 11C.

First, the cover 20 is placed at an angle on a frame 12, at its side lying opposite the recess 25, or the housing 40 with the latch 30, respectively, such that the lugs 13, or the latch counter bearing 14, 14′, respectively, engage(s) in the notches 23, and the notch ribs 27 are positioned beneath the lugs 13, or the latch counter bearing 14, 14′ (FIG. 10A/FIG. 11A).

When the cover 20 is then lowered, the bevel 31 engages with the likewise beveled upper surface of the latch counter bearing 14, 14′ (FIG. 10B/FIG. 11B), such that the snap bolt 30 is pushed back, against the force of the compression spring 33.

Once the final position has been reached, i.e., the cover 20 rests on the corresponding frame 12, the snap bolt 30 is forced outward by the compression spring 33, such that the retaining surface 32 of the latch 30 engages with the underside of the latch counter bearing 14, 14′. Thus, the cover is then held securely on the frames 12 of the channel body 11, or securely held on the structure, respectively. The cover 20 can no longer be lifted upward in this state, because, on one hand, the notch ribs 27 are locked in place beneath the lugs 13, or beneath the latch counter bearing 14, 14′, respectively. On the other hand, the lifting of the cover at the opposite side is prevented by the engagement of the retaining surface 32 of the latch 30 with the underside of the latch counter bearing 14, 14′.

In order to lift the cover, a tool, e.g. a screwdriver, is inserted between the two latch counter bearings 14, 14′. The front surface of the blade of the screwdriver then engages with the bevel 15, such that the screwdriver is forced toward the middle of the channel, as a result of which the screwdriver, in turn, pushes the snap bolt 30, against the force of the compression spring 33, into the housing 40. As a result, the retaining surface 32 is disengaged from the latch counter bearing 14, 14′. At the same time, by tilting the tool (screwdriver), the tool blade can then become engaged with the engagement bevel 43, by means of which the cover 20 can be lifted away from the frame 12. Thus, with a single tool, the latch is opened and the cover is lifted.

### LIST OF REFERENCE SYMBOLS

10 structure/drainage channel

11 channel body

12 frame

13 lug

14, 14′ latch counter bearing

15 bevel

16 tool passage

20 cover

21 rib

22 slot

23 notch

24 bearing surface

25 recess

26 retaining tongue

27 notch rib

30 latch (snap bolt)

31 bevel

32 retaining surface

33 compression spring

34 spring seat

35 clamping tongue

36 stop

40 housing

41 spring seat

42 lateral surface

43 retaining groove

44 guide

45 insertion opening

46 upper surface

47 recess

48 engagement bevel

1.-14. (canceled)

15. A kit, comprising a closure, a cover and a structure that can be installed in the ground, wherein the closure is adapted for locking the cover on said structure, and a latch which is formed in such a way and movably mounted in a housing against the force of a spring means, so that the latch is pushed back when closing the cover and is snapped in a closed position behind a structure fixed counter-bearing
characterized in that
the housing is non-detachably—and positively and frictionally engaged—fastened in a housing receptacle in a direction of movement of the latch in the cover, in its closed position.

16. The closure according to claim 15, characterized in that the housing receptacle comprises a recess on the edge thereof, in which the housing is secured in its closed position, such that it cannot be released.

17. The closure according to claim 15, characterized in that the housing is designed such that it is closed at its upper surface when in the closed position.

18. The closure according to claim 15, characterized in that the housing has a retaining groove or a retaining tongue, by means of which the housing can be secured in a recess in the cover, which has a complementary retaining tongue, or retaining groove, respectively.

19. The closure according to claim 18, characterized in that the housing is designed such that it can be inserted in the recess in a direction of movement for the latch.

20. The closure according to claim 15, characterized in that the housing and/or the latch are made of a plastic.

21. The closure according to claim 15, characterized in that the housing has a guide encompassing the latch.

22. The closure according to claim 15, characterized in that the latch has a stop, which limits its movement in the closing direction.

23. The closure according to claim 15, characterized in that the latch comprises a clamping device, by means of which the spring device can be connected to the latch.

24. The closure according to claim 15, characterized in that a front region of the housing from which the latch protrudes, the housing has an engagement recess, such that the latch can be slid back to an open position by means of a tool inserted from above through the engagement recess.

25. The closure according to claim 24, characterized in that the housing has an engagement bevel on its underside, beneath the latch, by means of which the cover can be lifted from the structure using a tool.

26. The closure according to claim 24, characterized in that the counter bearing has a two-part design, such that a tool, can be inserted between the two parts of the counter bearing, in order to engage with the latch.

27. The closure according claim 15, characterized in that a bevel is formed beneath the counter bearing such that a tool which is used for opening the latch, is displaced by means of the bevel in the opening direction.

28. A cover for covering a structure that can be installed in the ground, characterized by a closure according to claim 15.
